(19) United States
(12) Patent Application Publication
(10) Pub. No.: US 2006/0220855 A1
(43) Pub. Date: Oct. 5, 2006

(54) Tamper indicating saw tag system and method for using same

(76) Inventors: Clinton S. Hartmann, Dallas, TX (US); Lewis T. Claiborne, Richardson, TX (US); Paul S. Brown, Richardson, TX (US)

Correspondence Address: RF SAW, Inc.;Suite 400, 900 Alpha Drive, Richardson, TX, 75081-6625, US

(21) Appl. No.: 11/083,873

(22) Filed: Mar. 18, 2005

(51) Int. Cl. G08B 13/14

(52) U.S. Cl. 340/572.1; 340/505; 340/10.1

(57) ABSTRACT

Embodiments of the invention provide a tamper indicating system using surface acoustical wave tag devices. This is achieved by the use of at least two surface acoustical wave tag devices. In one embodiment, a first surface acoustical wave tag device returns an identification signal in response to an interrogation and a second surface acoustical wave tag devices returns an indication of tampering in response to an interrogation. An antenna assembly is provided comprising conducting elements each of which are deformed to form a partial helix. One element is spiraled in an opposite direction from the other and wherein the elements are arranged opposite each other in the form of a partial double helix

### TECHNICAL FIELD

The present invention is directed, in general, to SAW identification tags and, more specifically, to tamper indicating surface acoustic wave (SAW) identification tags having enhanced data content and to methods of operating and manufacturing the same.

### BACKGROUND

There is a global market for identification systems and services. Such identification systems are of vital interest to postal authorities, airlines and airports, mass transit authorities if they can proven to be, if not tamper resistant, then tamper indicative.

Familiar to all are the bar codes employed by businesses to perform identification functions and the various devices used to read them. Bar codes are most generally read by using a scanner (such as a bar code scanner and the like) to read the code which is displayed on paper or electronic displays and identify the item associated with that particular code. One such readability limitation is the range at which they can be used. Both are short range systems that require the reader to contact or be very close (a few centimeters, at most) to the bar code in order to decode data. They are also limited by the fact that no obstruction can be between the reader and the bar code for the reader to accurately decode data. As a result of these problems, each individual read operation requires manual scanning by a human operator if high read accuracy is needed. Thus, tampering with bar code labels can be easily identified by an operation be seeing physically that there has been on overlay of a bar code or removal of a bar code with replacement of another.

The radio frequency identification (“RFID”) tag is another prior art identification device. As the name suggests, when RFID tags are interrogated they reflect or retransmit a radio signal that returns encoded identification information. RFID tags have many uses, ranging from the collection of highway and bridge tolls to being embedding in objects to circumvent counterfeiters and to identify contents of containers including cargo containers. An advantage of RFID tags over bar codes is that they can generally be sensed at a somewhat longer distance without having as significant line-of-sight and orientation problems that are evidenced in bar code systems. However, such an advantage is a disadvantage for tamper indication as a human operator may not be able to visually inspect the tag.

RFID tag devices are of two basic types; those that contain a microchip and those that do not. There is a radical difference in cost and performance between the two types; to such an extent that they rarely compete with one another as to type of use. As a general rule, chip tags cost more by have a larger data capacity than chipless tags. Integrated Circuit-Chip (IC-Chip) tags, for example, are usually not available below a unit cost of about one dollar each when ordered in a quantity of less than one million; whereas many chipless tags are projected to cost less than 20 cents each, even when ordered in quantities of one hundred thousand.

IC-Chip tags are in wider use than other style tags. An IC-Chip tag consists of four elements or features: (1) a computer microchip; (2) circuits for converting radio signals to computer data signals and back to radio signals; (3) an antenna; and (4) a means for providing DC power to the chip circuitry. In low cost RFID chip tags, the first two features are often partially or totally integrated into a single microchip, which integration requires certain compromises in tag performance (read range, number of bits, etc.). This combination of features also leads to certain integrated circuit (IC) cost and/or design compromises to accommodate both digital and radio frequency circuitry on a single IC. The impact of these design compromises can be partially compensated for by use of low radio frequency (RF) operating frequencies that, in turn, lead to rather large and expensive antennas.

The most daunting problem with chip tags is the need for DC power for the chip circuitry. The combination of environmental issues coupled with severe constraints on cost, size and weight usually requires that the tag not have a battery or other on-board power source. The only generally useable solution is to obtain DC power by converting RF power received from the tag reader signal into DC power within the tag. Those skilled in the pertinent art term tags without a battery or other power source as “passive” tags, while those that contain a battery or other source are termed as “active” tags. The passive method of providing DC power to a chip tag requires a more efficient tag antenna (i.e., larger size and cost) and higher transmitted power levels from the reader. It also requires added components which will either add to the cost of the microchip or to the cost of the tag for the required extra electrical components in the tag, which additional components will also result in an increased tag size. However, IC-Chip tags can actively transmit an indication that they have been tampered with as long as the battery power does not run out.

“Chipless” RFID tags do not contain a microchip but, instead, rely on magnetic materials or transistorless thin film circuits to store data. A major advantage of chipless RFID tags is their relatively low cost. The disadvantages of chipless tags include that they are range limited (several centimeters at the most) and only contain limited amounts of information. The severity of these problems has prevented their market acceptance in spite of their low cost potential.

Another type of identification tag SAW-based RFID has been develop by RF SAW (Richardson, Tex.) and uses Surface Acoustic Wave technology to provide identification information. Such tags and readers for use with same are taught in U.S. Pat. No. 6,759,789 issued on Jul. 6, 2004, and U.S. Pat. No. 6,708,881 issued on Mar. 23, 2004, both to Clinton S. Hartmann. Both patents assigned to assignee of the present patent application herein incorporated by reference.

Accordingly, what is needed in the art to provide identification tags using SAW based RFID, which may indicate possible tampering.

### SUMMARY

In light of the foregoing background, embodiments of the invention provide a tamper indicating system. This is achieved by the use of one or more tag devices.

In one embodiment, a first tag device returns an identification signal in response to an interrogation and a second tag devices returns an indication of tampering in response to an interrogation.

In another embodiment, a single tag is used to indicate tampering by the absence of a response to an interrogation.

In an additional embodiment, a deformed folded-dipole antenna is used in a bolt seal device. The antenna assembly comprises conducting elements each of which are deformed to form a partial helix. One element is spiraled in an opposite direction from the other and wherein the elements are arranged opposite each other in the form of a partial double helix.

. . . Therefore, the system and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is illustrative of a plan view of an embodiment of a SAW identification tag with an antenna configured to provide a return signal with a specific number encoding therein by both pulse position and phase position;

FIG. 2A shows two SAW tags connected by a cable;

FIG. 2B shows two SAW tags connected by a cable, wherein the cable has been disconnected;

FIG. 3A shows two SAW tags on a glass substrate;

FIG. 3B shows two SAW tags on a substrate, wherein one tag has been disconnected

FIG. 4 consisting of FIGS. 4A to 4D is illustrative an example of digital PPM showing four positions of a time span for transmitting data using conventional PPM;

FIG. 5 is illustrative of a tag ID signal with no seal;

FIG. 6A is illustrative of a tag ID signal with a SAW device shorted as an indicating seal;

FIG. 6B is illustrative of a tag ID signal indicating tampering;

FIG. 7A is a diagram showing an arrangement in accordance with an embodiment of the invention;

FIG. 7B is illustrative of a return signal of the arrangement in FIG. 7A with seal intact;

FIG. 7C is illustrative of a return signal of the arrangement in FIG. 7A indicating tampering;

FIG. 8A is a diagram showing an arrangement in accordance with an additional embodiment of the invention;

FIG. 8B is illustrative of a return signal of the arrangement in FIG. 8A with seal intact;

FIG. 8C is illustrative of a return signal of the arrangement in FIG. 8A indicating tampering;

FIG. 9 is illustrative of another embodiment of the attached to a typical locking bar which is used to lock a cargo container;

FIG. 10 is illustrative of a tamper indicating bolt sealing device in accordance with another embodiment of the invention;

FIG. 11 is illustrative of a tamper indicating bolt sealing device in accordance with an additional embodiment of the invention; and

FIG. 12 is illustrative of a deformed folded-dipole antenna which may be used in various embodiments of the invention and other applications.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Some on the embodiments may include RFID non-SAW tag devices and one should not read limitations into the claims. Like numbers refer to like elements throughout.

The following will describe a system and method of delivering services to a receiving entity.

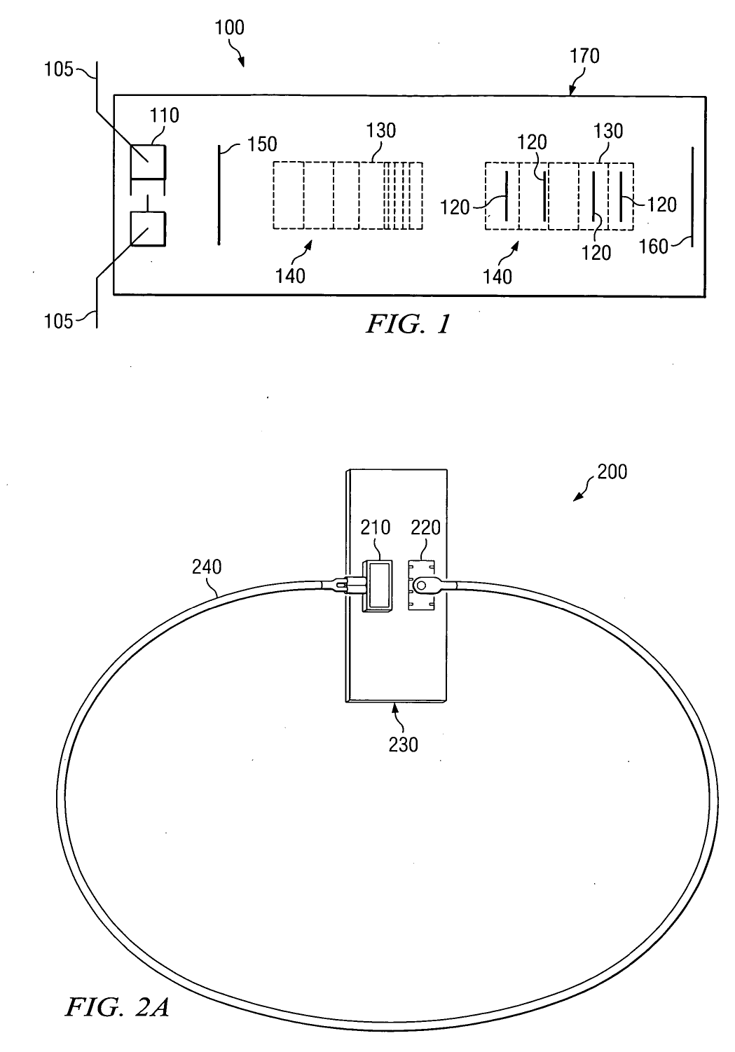

Turning now to FIG. 1 is a plan view illustrative of an embodiment of a SAW identification tag 100 with an antenna 105 configured to provide a return signal with a specific number encoding therein by both pulse position and phase position. The SAW tag 100 has a transducer 110 at one end where an antenna 105 is used to receive an interrogation signal from the SAW tag reader. A SAW is generated that proceeds down the surface of the SAW tag 100 and encounters reflectors 120 arranged by both pulse position and phase position so that the return signal will have a number encoded therein that is uniquely associated with the interrogated SAW identification tag 100. The Applicant has also coined the term Global Surface Acoustic Wave Tags (GST) to name such devices, also known as SAW RFID systems. SAW RFID systems provide for a longer reading range than typical RFID systems can provide. The tag devices described may provide identification information of a container, the contents of the container, the route a container is to take and any other information which may describe or identify articles in transport or the containers transporting them. Therefore, even though the term identification may be used in the specification other information may be programmed into the tags. One of the benefits of using GSTs is that more bits of information may be programmed into the tags than with earlier RFID tags.

Located on the surface of the SAW tag 100 are one or more groups 140 of slots 130 that are arranged by pulse position and phase position. Of course they could also be arranged by pulse position, phase position and amplitude position and still be within the intended scope of the present invention. The number of slots 130 and their arrangement is dependent on the encoding system being used. The reflectors 120 may to be arranged such that the phase position is in quadrature. Those of ordinary skill in the pertinent art will understand that other embodiments of the invention may use different phase positions requiring different arrangements of slots 130 within a group 140 as well as a different number of slots 130 and groups 140 and still be well within the intended scope of the present invention.

A SAW identification tag reader is used with SAW tags 100 that have a framing reflector 150 located between the transducer 110 and the group 140 of slots 130. Such a framing reflector 150 can be regarded as the starting point in the return signal where the SAW identification tag reader can start detecting a coded identification number. An end reflector 160 is located on the SAW tag 100 after the group 140 or groups 140 of slots 130. The end reflector 160 together with the framing reflector 350, serve to frame a return signal for the SAW identification tag reader to decode. The illustrated SAW tag also shows a dead space 170 separating each group 140. This dead space 170 serves to separate groups 340 and decrease inter-symbol interference.

To understand the arrangement of reflectors 120 on a SAW tag 100 and the return signal that have a unique number encoded therein, it is helpful to consider relevant signal modulation methods. In conventional pulse position modulation (PPM) a data stream can be coded by dividing it into separate sample values where a single pulse is used to transmit information contained in a sample. Changing the time position of that single pulse over a predetermined span of time serves to transmit the information in that sample. Single pulses in subsequent time spans are similarly used to transmit information in subsequent sample values.

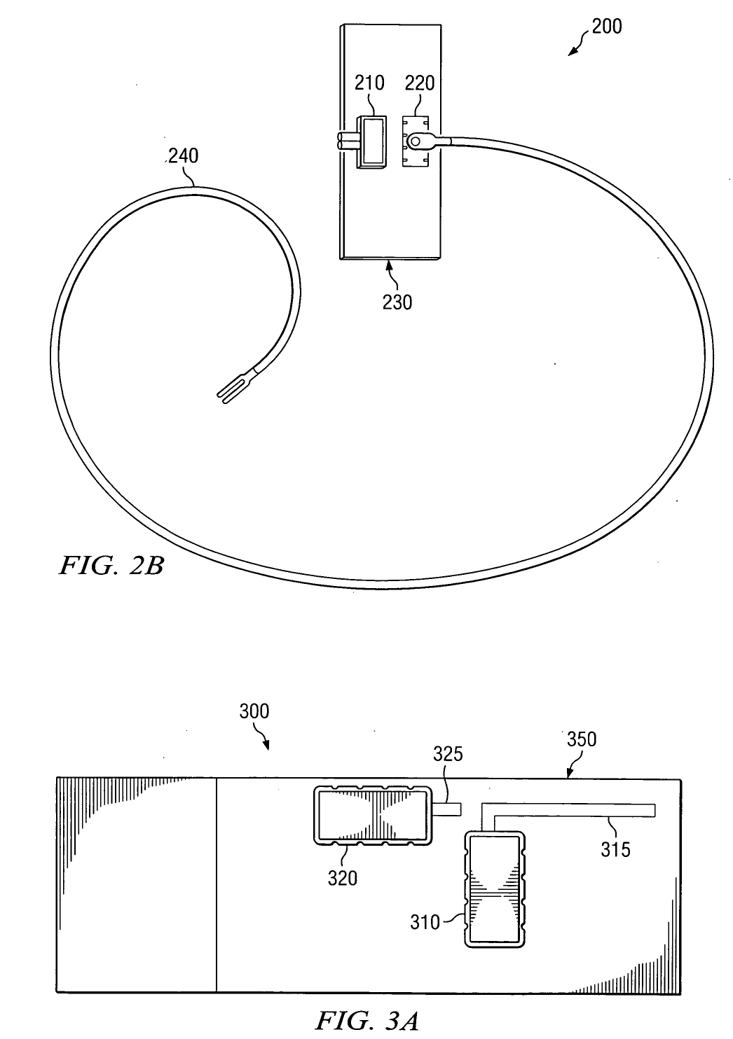

Turing to FIG. 2A two SAW tags 210 and 220 are included in a seal arrangement 200. The tags are secured to a substrate 230 and are interconnected with a cable 240. As is showed in FIG. 2B, cable 240 may be disconnected form either SAW tag 210 or 220.

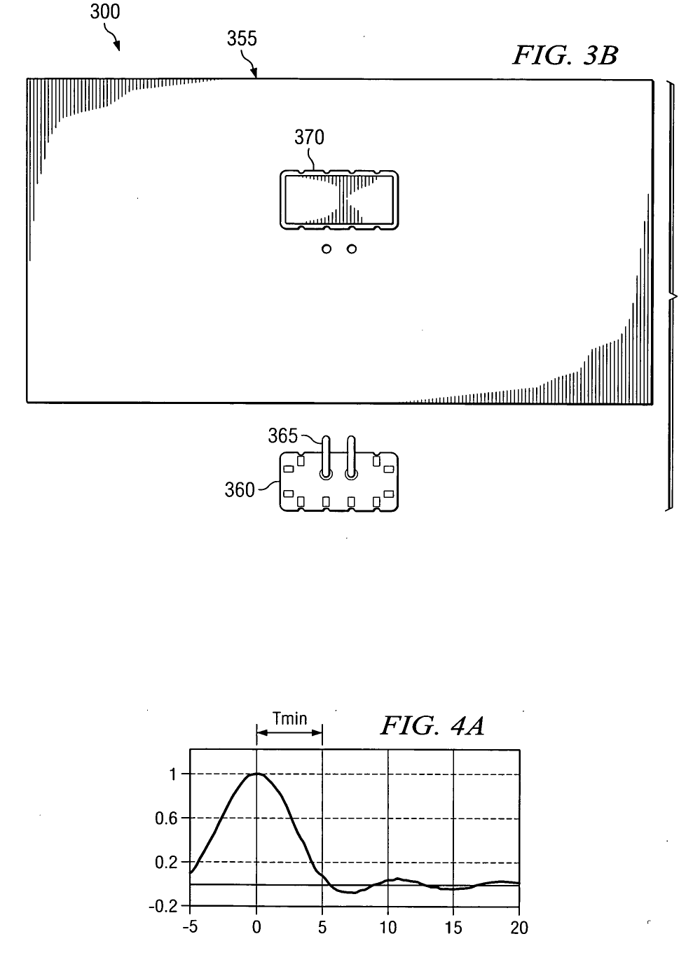

FIG. 3A is illustrative of another embodiment of the invention. The arrangement 300 in FIG. 3A shows two tags 310 and 320 attached to the same substrate 350. The tags may be interconnected 325 and provided with antenna 315. Substrate 350 may be glass or other material and may be scored as to provide breakable areas if substrate 350 is stressed. Thus, arrangement 300 is used to seal an opening and pressure is applied to substrate while attempting access to opening, substrate will break in area of scoring such as the interconnection 325 of the two tags 310 and 320. Metal strip lines may also be used to make substrate frangible.

FIG. 3B shows a variation in which one tag 370 may be attached to the substrate which is attached to a first part of an opening. A second tag 360 is attached to a second part of an opening and in normally untampered with coupled to tag 370 by leads 365.

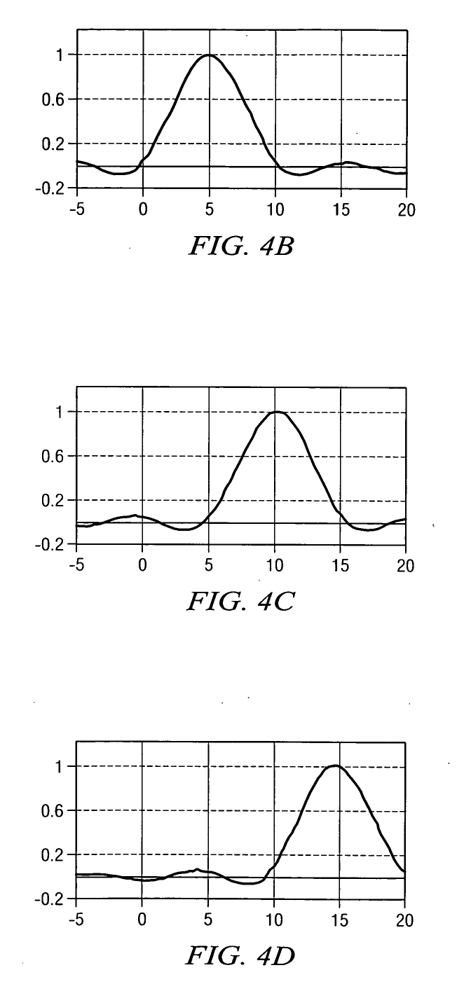

Turning now to FIG. 4 consisting of FIGS. 4A to 4D, illustrated is an example of digital PPM showing four pulse positions of a time span where data can be transmitted using conventional PPM. In this case, the sample to be transmitted is digital and has one of four possible values. Shown are four possible waveforms, which consist of nominally identical single pulse waveforms whose time positions can be centered in one of four time locations or pulse positions. The minimum time spacing required between pulse positions to ensure that skirts from neighboring pulse positions are essentially zero at the peak of any selected pulse is Tmin. Of course, pulse spacing wider than Tmin can be used without affecting the ability to demodulate a PPM signal, however, if pulses positions are spaced more closely than Tmin, it becomes more difficult to unambiguously distinguish one pulse position from its neighbor. Using a reader to sampling the PPM waveform at each of the four possible peak pulse positions and selecting the largest one results in the demodulation of conventional PPM. It is readily apparent to those of ordinary skill in the relevant art that the demodulation process must be synchronized using one of a number of synchronization methods known in the art.

The four possible pulse positions represent two binary bits of data. A subsequent group of four pulse positions occupied by a single pulse can represent an additional two binary bits of data. As many sequential groups of four pulse positions as necessary can be used to represent a desired data word containing many bits of information.

PPM modulation is a favored modulation method for RFID tags based on SAW devices, because (1) a single pulse can be readily created and programmed by a SAW reflector placed on the SAW substrate, (2) the various pulse time positions directly relate to the spatial place of possible SAW reflectors, (3) the number of data bits is greater than the number of signal pulses which reduces tag insertion loss and (4) the number of SAW reflectors remains constant for all possible tags identification numbers which leads to reasonably low loss tags with uniform pulse amplitudes for any tag identification. However, the use of PPM for SAW RFID tags also has limitations including: (1) PPM data density is low, which increases the chip size (and hence cost); (2) the low data density combined with practical maximum sizes for SAW chips creates an upper limit on the number of bits for practical tags; and (3) multi-bounce reflections between the various reflectors in a PPM SAW tag create unwanted pulses that can interfere with later portions of the PPM pulse train.

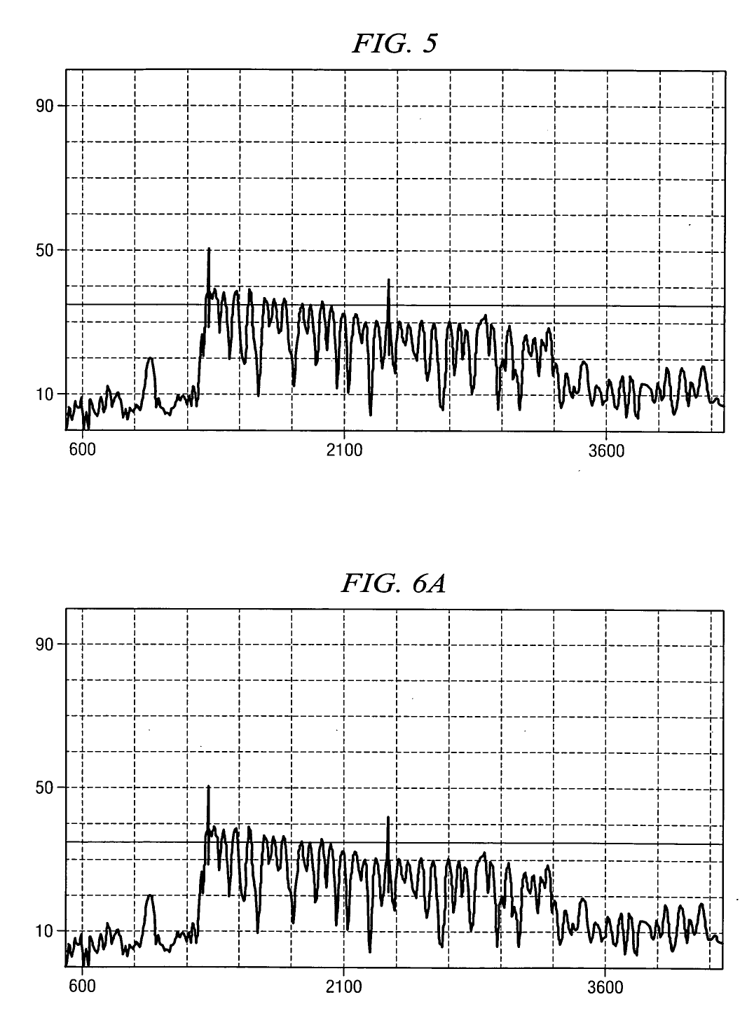

FIG. 5, which shows a typical return signal in the time domain from a tag.

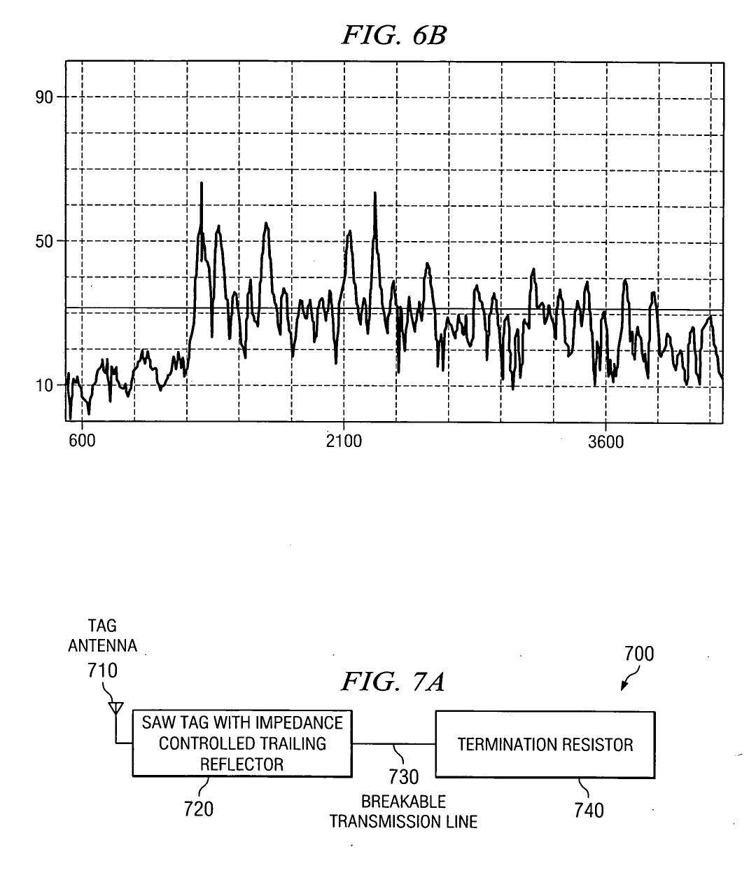

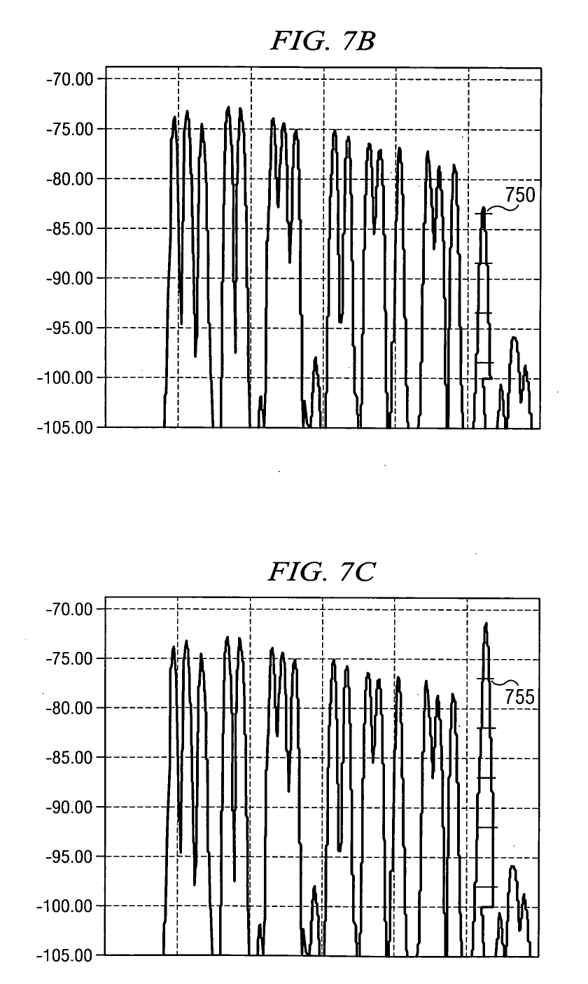

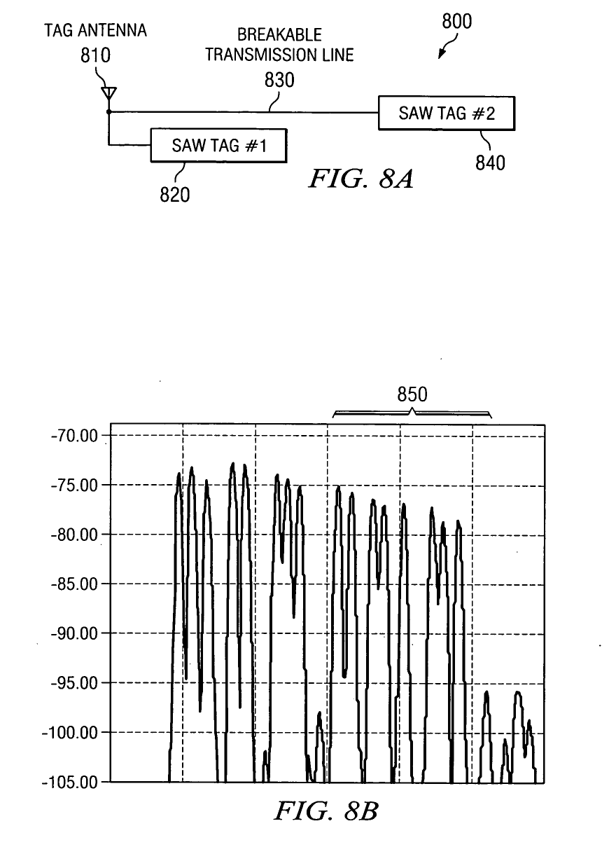

FIG. 6A shows the signal in the time domain of a tag device in which the signal from the tag device is delayed in time domain has a short as a seal. FIG. 6B shows the signal in the time domain of the tag device but with the seal broken (i.e. the second tag device in time without a short. Note that as shorted in FIG. 6A, there is no return signal from first tag device. However, as can be see in FIG. 6B, the second tag device returns a signal when the short is removed thus indicating tampering.

FIG. 7A is a diagram showing a circuit in accordance with an embodiment of the invention using a single tag. Arrangement 700 included antenna 710, tag device with impedance controlled trailing reflector 720, a breakable transmission line 730 and terminating resistor 740. Breakable line may be made of scored metal line, conductive inks or conductive powders and the like known in the art.

FIG. 7B is illustrative of a return signal from the arrangement in FIG. 7A with breakable transmission line 730 unbroken (i.e. no tampering has occurred) and FIG. 7C is illustrative of a return signal from the arrangement in FIG. 7A with breakable transmission line 730 broken (i.e. tampering has occurred). Note the change of the trailing pulse of unbroken line 750 to that of broken transmission line 755. Because the circuit no longer has a terminating resistor in connection with the rest of the circuit, the amplitude of the trailing pulse is higher in the broken transmission line signal.

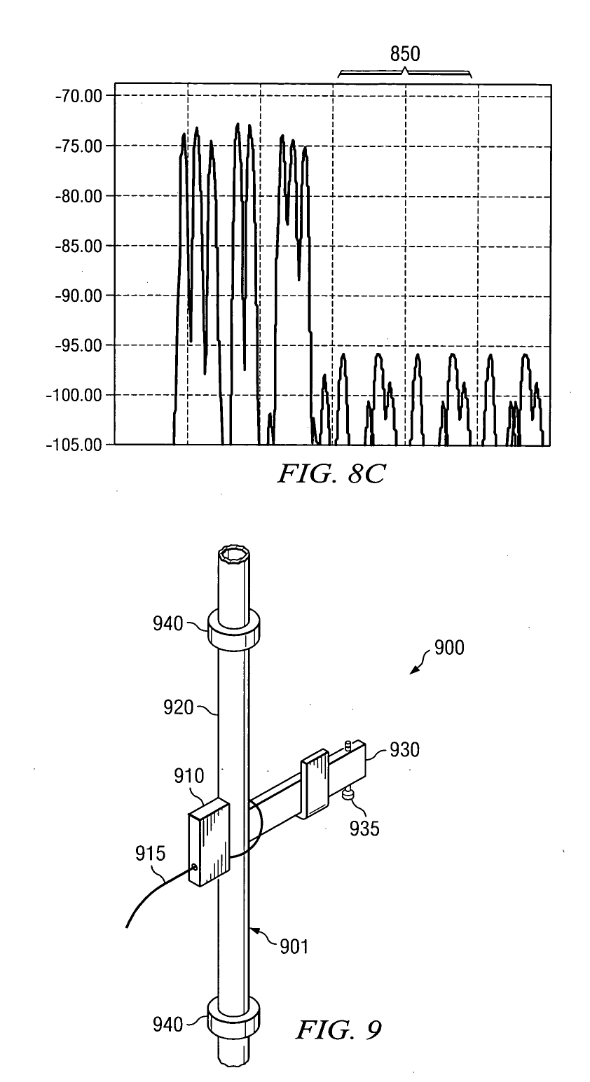

FIG. 8A is a diagram showing a circuit in accordance with an embodiment of the invention using two tag devices. The arrangement 800 includes an antenna 810, a first tag device 820, a second tag device 840 coupled to first tag device via a breakable transmission line 830. Breakable line may be made of scored metal line, conductive inks or conductive powders and the like known in the art.

FIG. 8B is illustrative of a return signal from the arrangement in FIG. 8A with breakable transmission line 830 unbroken (i.e. no tampering has occurred). FIG. 8C is illustrative of a return signal from the arrangement in FIG. 8C with breakable transmission line 830 broken (i.e. tampering has occurred). Of note from the figures in the change in the signal in the time area of 850. Identification information is still provided by the first tag device 820 because first tag device is still coupled to antenna 810. However, signal from second tag device 840 is not available to reader because second tag device 840 has been decoupled from antenna 810.

Systems in accordance with embodiments of the present invention may be seals themselves or be attached to existing seal technology to provide electronic indication of tampering. An example is a tape which has properties which change when tape is tampered. Embodiments of the invention could be part of tamper indicating tape which changes color when tampered. An improvement on this tape seal could be that conductive power or ink is used to block signal for one of a plurality of SAW or other type of tag devices. When tape seal is intact, interrogation signal can not get to the conductive tape covered identification device. Breaking the seal destroys the conductivity of the tape and allows for interrogation signal to get pass the tape and to the formally conductive tape covered tag device. This would provide both a visual and electronic indication of tampering

Applicant deems that both reception of a signal when no signal was expected and no reception of a signal when one was expected are both electronic indications of tampering. In other words, electronic indication of tampering includes the destruction of the tag in such a way as to prevent response to interrogation.

Another indication of tampering may result in shorting and unshorting the SAW devices. For example, a SAW device may be permanently mounted onto the door or other type opening to a container. A tamper indicating seal such as tape may be mounted across the opening and the SAW device in such a manner as to short out the SAW antenna terminals. When the tape is peeled from the door to open it, the SAW device becomes un-shorted and responds to interrogating readers with a tamper indicating signal.

The SAW or other type of tag devices may also be embedded in molded plastic housings. The housings may be attached to locations in such a way that opening a container destroys the housing, antenna and/or identification device itself.

FIG. 9 is illustrative of a tamper indicating system 910 in use with a typical cargo container with rolling bar locking mechanism also referred to as “locking bars.” System 900 comprises a cargo container door 901 to which is coupled a locking bar mechanism further comprising locking bar 920 loops to hold the locking bar 920 into place 940, latch bar 930 to placed into lockable latch 935. Locking bar 920 is free to move up and rotate so that latch bar 930 can be pull up and rolled free of latch 935. Loop 915 is an insulated conductor with a first end fixed to a first tag device and a second end capable of being attached to a second tag device. Various methods may be used to attach the second end to a second tag device such as hardwire connection, plug and socket connections and the like. These connections can be made in connection box 910 and then be covered by a secured non-removable cover. Another way to provide for interconnection is for the second end to pass through receiving hole in connection box 910 passing through a one way latch which has teeth which would let cable pass-in through box 910 but can not be pull the other direction. A pull in a second direction brings teeth down to pierce insulation and make a conductive contact with second tag device.

Instead of the conductive cable, a molded plastic housing as described above may be placed between the bar 920 and the container door 901 in such a way as rotating the bar destroys the molded plastic housing and thus the antenna or the tag device itself. This would provide visual and electronic indication of tampering.

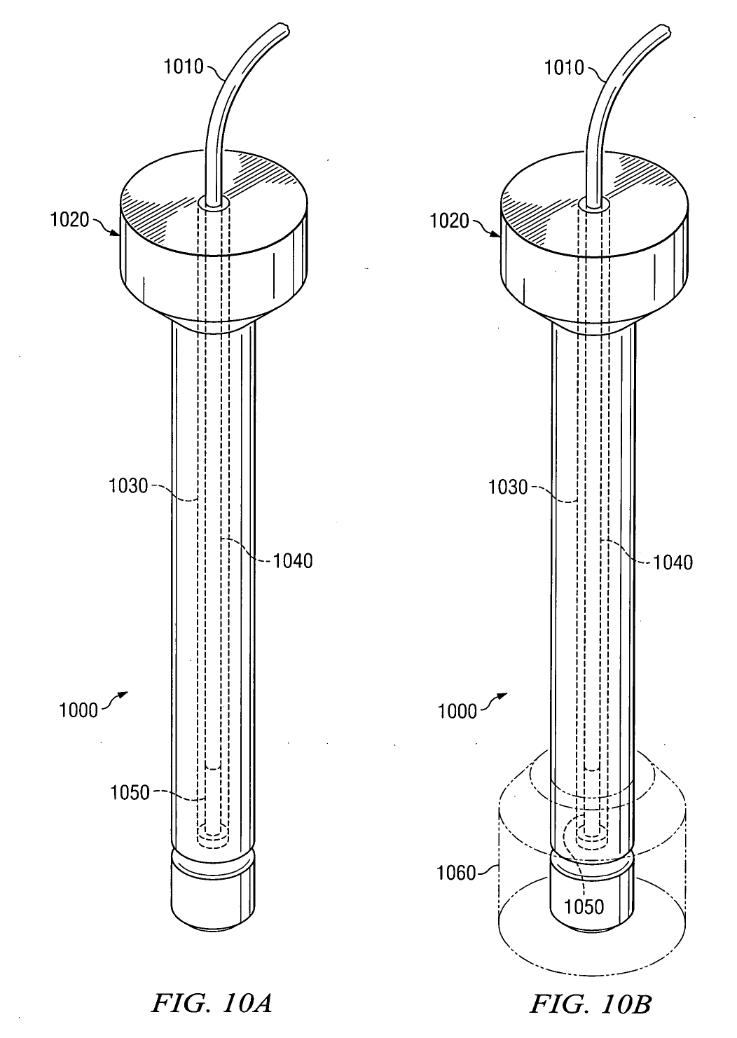

FIG. 10 is illustrative of a tamper indicating bolt seal in accordance with an embodiment of the invention. Tamper indicating bolt seal device 1000 comprises bolt 1020 with a shaft, tag insertion hole, bore hole or channel 1030 which may be central to longitudinal axis of bolt or drilled off-center to bolt's longitudinal axis in the shaft. An antenna 1010 which may be monopole antenna, dipole antenna, loop antenna, helical, patch antenna, ceramic antenna or the like. Antennas may be made of any conductive material including but not limited to metals, conductive inks, organics compounds such as polymers and also ceramics. Antenna may also have structure internal to bolt, external to bolt, or integral to the construction of the bolt 1020 provides for communication of interrogation signal to and return signal from a tag device 1050 disposed inside bolt via transmission line 1040. Location may be anywhere inside the bolt. Preferably the location should be such that the cutting of bolt 1020 would also destroy tag device 1050. However, mechanical and chemical agents may be employed to destroy tag device 1050 when bolt 1020 is compromised by cutting, use of acid or other destruction mechanisms. The bolt itself may be made of materials such a glass which would shatter when broken, thus destroying the tag or antenna or both and provide both a visual and electronic indication of tampering.

The bolt has certain material properties such as strength, conductivity and the like. There may be an agent inside bolt 1020 which may act upon the bolt to change its properties. Strength may be changed in such a way as to compromise the integrity of the bolt's structure and thus, provide a self-destruct mechanism. Agent may be corrosive such acid or base. The agent may also be binary agents which when combined upon compromise destroys the tag device. Binary agents may be such that when combined become conductive and when around tag device prevent interrogation of tag device. Another variation is that the chemical agent provides power to an active tag to provide a beacon which broadcasts alert that tampering is or has occurred.

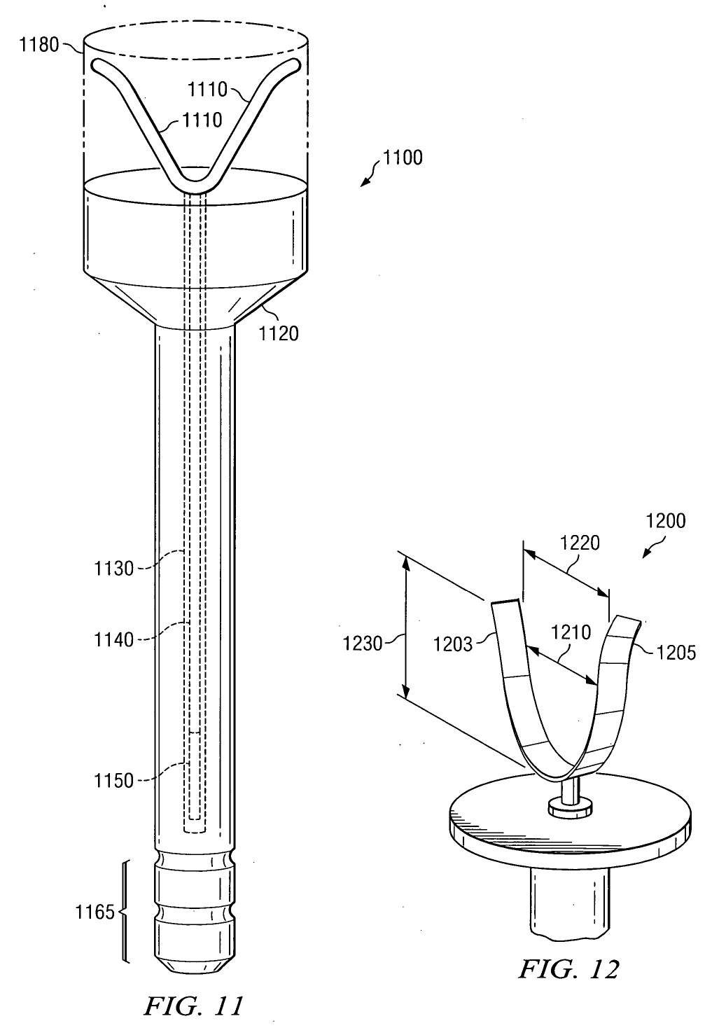

Bolt 1020 may be be used to seal a door such as the doors of cargo containers, shipping pouches and the like by insertion in a locking receiving unit 1060. Locking structure 1065 of bolt 1020 is insert locking receiving unit 1060. Locking structure 1065 may be groove or set of grooves to correspond to structures inside locking receiving unit 1060. Locking receiving unit 1060 is a one way locking device in that bolt 1020 once inserted cannot be removed without special tool and/or destruction of bolt 1020. Locking receiving unit 1060 may have rings that latch onto grooves on the shaft of the bolt. Other variations to locking receiving unit 1060 may be used. Variations such as a double ring locking mechanism such as shown in FIG. 11 may also be used. Bolt passing through a hole in wall of a container and into receiving hole in door which is to be seal. Tag 1050 may contain an identification of the container itself or other information which when not available after interrogation indicates tampering. Container identification tag may also be permanently attached to container and a companion tag may in bolt so that container may always have electronic ID, but lack of information from bolt tag indicates tampering.

Bolt 1020 may be may of material which may shatter and destroy tag device when attempt is made to disturb the bolt.

In the alternative, Bolt 1020 may be constructed of such material as to be able to withstand being welded to container as another way to seal container.

Containers may be packages, mail or drop boxes, shipping containers and other like containers.

FIG. 11 is illustrative of a tamper indicating bolt sealing device in accordance with an additional embodiment of the invention. Tamper indicating bolt sealing device 1100 comprises, a bolt 1120, a tag insertion hole or channel 1150 and a SAW tag device 1150. However, unlike the locking structure 1065 of FIG. 10, locking structure 1165 has a double locking structure to make it harder to pry open a receiving unit, by the use of multiple grooves. A receiving unit such similar to that of 1060 in FIG. 10 but constructed to lock on to multiple grooves may be used. Locking structure 1165 of bolt 1120 is insert a locking receiving unit (not shown on FIG. 11) but similar to that shown in FIG. 10. Locking receiving unit 1160 is a one way locking device in that bolt 1120 once inserted cannot be removed without special tool and/or destruction of bolt 1120.

Tamper indicating bolt sealing device 1100 further comprises a balanced (symmetrical) transmission line 1140 to transport signals between a symmetrically deformed folded-dipole antenna 1110 and SAW tag device 1150.

A balanced transmission line is used to reduce the effects of the materials from which the bolt is constructed.

The symmetrically deformed folded-dipole antenna 1110 is not limited to the tamper indicating bolt sealing device 1100 but may be used as an antenna on other systems. Symmetrically deformed folded-dipole antenna 1100 is a folded dipole antenna but has a structure similar to that of a partial turn of the opposing spirals of a double helix. This structure provides a good omnidirectional transmission pattern allowing reading from most angles. Further description of this novel antenna structure is provided below in the description of FIG. 12.

The antenna assembly is encapsulated in a dielectric material 1180 encasement solid enough to protect the antenna. It is best that this dielectric material be as lossless as possible as not to attenuate the interrogation or response signal. However, for active tags and other applications, ferroelectric materials may be introduced with may change the dielectric properties of the dielectric by applied voltage.

FIG. 12 is illustrative of a deformed folded-dipole antenna in accordance with an embodiment of the invention. Those skilled in the art can determine various other dimensions depending on pattern needed and materials used as dielectric constant changes tuning of antenna with dimensions changed accordingly. Therefore, the following description for a deformed folded-dipole antenna are exemplar only. FIG. 12 shows a deformed folded-dipole antenna 1200. Antenna 1200 is in two parts or elements 1203 and 1205 each driven by a different conductor of a balance transmission line. Elements 1203 and 1205 may be coupled to conductor or may be an end of the conductor. Each element is deformed into a partial turn of a spiral or helix. One element spiraling in the opposite direction of the other. When mounted on bolt or other device together they form a partial double helix. The approximate dimensions of an exemplar are diameter 1210 of 21.3 millimeters, height 1230 of 18.5 millimeters, and gap 1220 of 13.3 millimeters.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A tamper indicating system for providing a seal to a container, said system comprising:
at least one surface acoustic wave tag device;
an antenna coupled to said surface acoustic tag device; and
a tamper indicator.

2. A tamper indicating system according to claim 1, wherein the at least one of the surface acoustic wave tag device returns an identification signal in response to an interrogation; and
wherein a second surface acoustic wave tag device returns an indication of tampering in response to an interrogation.

3. A tamper indicating system according to claim 1, further comprising:
a second surface acoustic wave tag device coupled to the at least one surface acoustic wave tag device operable to produce a combined signal indicating a state of the seal.

4. A tamper indicating system according to claim 3, wherein the at least one and the second surface acoustic wave tag devices are mounted on a frangible plate and are coupled to an antenna through scribed lines in the frangible plate in such a way as the antenna connection is broken when the frangible plate is broken.

5. A tamper indicating system according to claim 3, wherein the identification signal provides an identity of the seal.

6. A tamper indicating system according to claim 3, wherein the identification signal provides an identity of the container.

7. A tamper indicating system according to claim 6, wherein identity of the container is provided even if the seal is broken.

8. A tamper indicating system according to claim 7, wherein tamper indicating system is permanently affixed to the container.

9. A method for providing a tamper indicating system in the transport of articles, said method comprising:
placing a plurality of articles to be transported into a container;
applying a tamper indicating device to the container, said device responses to an interrogation signal and returns at least an identification of the container and an indication of tampering.

10. A method for of claim 9 wherein the tamper indicating device is applied to a seal to the container and in which tampering of the seal provides both a visual and electronic indication of tampering.

11. A method for of claim 10 wherein the seal is a tape has properties that change upon tampering to provide visual indication of tampering.

12. A method for of claim 11 wherein the tape is applied to the container by placing the tape across the opening of the container.

13. A method for of claim 12 wherein the seal is looped around at least two vertical bars of the containers wherein the at least two vertical bars must be rotated in order to open the container and wherein rotating the bars breaks the seal.

14. The method of claim 10, further comprising:
applying a second tamper indicating device, wherein the second tamper indicating;
providing an identification signal from one of the tamper indicating devices; and
providing a tamper indicating signal.

15. The tamper indicating system of claim 1 further comprising:
a bolt having a shaft and a bore hole within said bolt's longitudinal axis of said shaft where the least one surface acoustic wave tag device may be disposed;
at least on conductive line coupled to said bolt;
an antenna coupled to said transmission line; and
an one-way locking means of securing bolt in such a way that

16. The tamper indicating system of claim 15 further comprising:
an agent within said bolt to change at least one property of the bolt.

17. The tamper indicating system of claim 16 wherein the change the properties of the bolt.

18. The tamper indicating system of claim 16 wherein the change the properties of the bolt.

19. An antenna assembly, comprising:
two conducting elements each of said elements deformed to form a partial helix one spiraled in an opposite direction from the other and wherein the elements are arranged opposite each other in the form of a partial double helix.

20. The antenna assembly of claim 19, further comprising:
a dielectric encasement for the antenna assembly solid enough to prevent antenna assembly from being damaged.
